(19) United States
(12) Patent Application Publication
(10) Pub. No.: US 2015/0002822 A1
(43) Pub. Date: Jan. 1, 2015

(54) PROJECTORS

(71) Applicant: Shigeo Hamamura, Tokyo (JP)

(72) Inventor: Shigeo Hamamura, Tokyo (JP)

(21) Appl. No.: 14/378,036

(22) PCT Filed: Mar. 8, 2012
(86) PCT No.: PCT/JP2012/056006

§ 371 Date: Aug. 11, 2014

(51) Int. Cl. G03B 21/20; G03B 21/00

(52) U.S. Cl. CPC G03B 21/2086; G03B 21/008
USPC 353/31

(57) ABSTRACT

A projector has a light modulating device that uses laser beams as display image light and includes a marker plate that is located on a non-reflection surface of a mirror that reflects the laser beams to the light modulating device, the marker plate being excited by the laser beams and generating fluorescence having a wavelength different from that of the laser beams.

### TECHNICAL FIELD

The present invention relates to projectors, in particular, to those that use lasers as light sources.

### BACKGROUND ART

In recent years, semiconductor lasers that output high intensity visible light have been realized. In addition, the manufacturing of high luminance projectors that use such semiconductor lasers has been proposed. Patent Literature 1 (JP2011-527766A, translation version) discloses a projector in which a dichroic combiner combines a plurality of laser beams and generates illumination light.

In a projector that uses the foregoing laser beams, the laser beams are modulated by light modulation devices—a DMD (Digital Mirror Device) and a liquid crystal device—and the modulated laser beams are projected as display image light outside the projector.

Various optical elements—minors, lenses, and an integrator—are located between the laser beam sources, which generate laser beams, and the light modulating device such that the light modulating device is effectively irradiated with the laser beams. In addition, various optical elements—a projection lens that projects the display image light that is output from the light modulating device to the outside of the projector—are located in the direction from the light modulating device to the outside. The positions of these optical elements are adjusted while laser beams are output from the laser beam sources and variations of the output states of the laser beams are observed.

### RELATED ART LITERATURE

### Patent Literature

Patent Literature 1: JP2011-527766A, Translation Version

### SUMMARY OF THE INVENTION

### Problem to be Solved by the Invention

As described above, the positions of the optical elements are adjusted while laser beams are output from the laser beam sources. Since the laser beams that are output from the laser beam sources have a high energy per unit area, the laser beams are very dangerous for human bodies, especially human eyes. Thus, during the period in which the laser beams are output, an indicator lamp is turned on so as to warn the user that the laser beams are being output.

When workers who develop, manufacture, maintain, and perform the related works for projectors that use lasers as light sources perform such tasks in the neighborhood of the projectors, they should wear protective eyeglasses that protect their eyes from scattered light. However, if the workers wear such protective eyeglasses, since they absorb laser beams, the beams become invisible. Thus, an indication lamp is mounted on the projector such that while laser beams are being generated, the indicator lamp warns the wearers that they should make sure to wear the protective eyeglasses.

High luminance projectors tend to use high intensity laser beams. Thus, if high intensity laser beams are used, it is necessary to ensure that the indicator lamp is turned on.

The indicator lamps include an incandescent bulb, a discharge tube, and an LED (Light Emitting Diode) that are turned on in conjunction with the light emission control of the laser beam sources. However, there is the likelihood that the indicator lamp will not function properly during the period in which the laser beams are being output due to various causes, such as failure of the indicator lamp itself, breakage of the power cable for the indicator lamp or forgetting to connect the power cable.

Since the indication lamp is expected to be mainly used for the benefit of the projector's user rather than workers who develop, manufacture, maintain and perform tasks related to operating the projector that uses lasers as light sources, the indication lamp is typically positioned at a location where the user can easily view the indication lamp, when the projector is projecting image light—for example, the outer position of the enclosure of the projector.

The enclosures of the projectors include—a detachable type enclosure that can be detached from the main body of the projector and an openable type enclosure that openably encloses the main body of the projector. Since the optical elements are located in the projector, when the positions of the optical elements are adjusted, the enclosure is detached or opened from the projector. Thus, the worker who adjusts the positions of the optical elements cannot view the indicator lamp.

An object of the present invention is to realize projectors that enable users and workers, who adjust the positions of the optical elements, to verify whether laser beams are being output.

### Means that Solve the Problem

A projector according to the present invention is a projector that has a light modulating device that uses laser beams as display image light, includes a marker plate that is located on a non-reflection surface of a mirror that reflects the laser beams to the light modulating device, the marker plate being excited by the laser beams and generating fluorescence having a wavelength different from those of the laser beams.

### Effect of the Invention

Whether laser beams are being output is indicated by fluorescence emitted from a fluorescent material excited by laser beams as excitation sources. Thus, since both the user and worker of the projector can easily confirm whether laser beams are being output, the projectors according to the present invention can provide both their users and workers with greater safety.

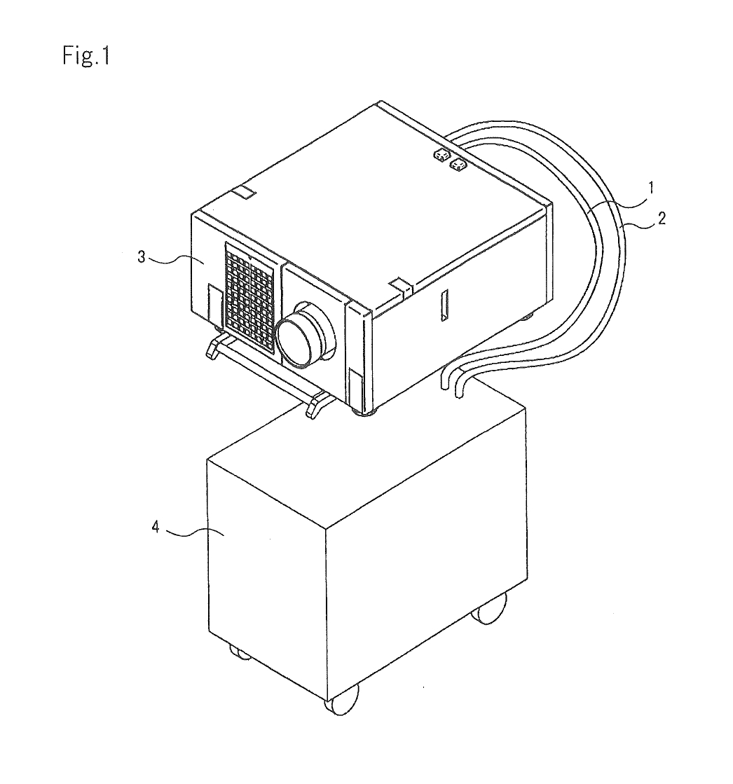

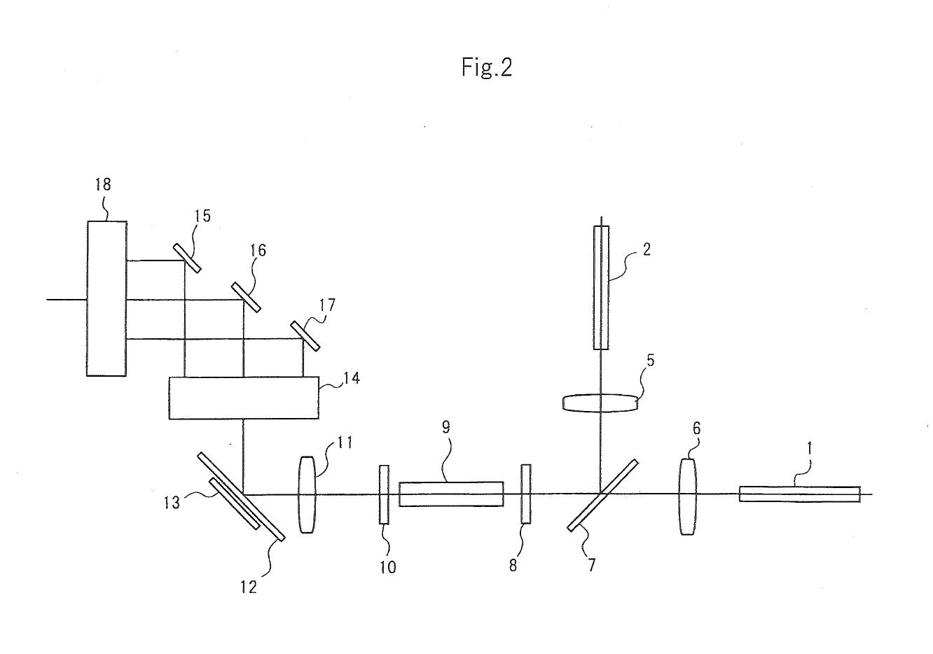

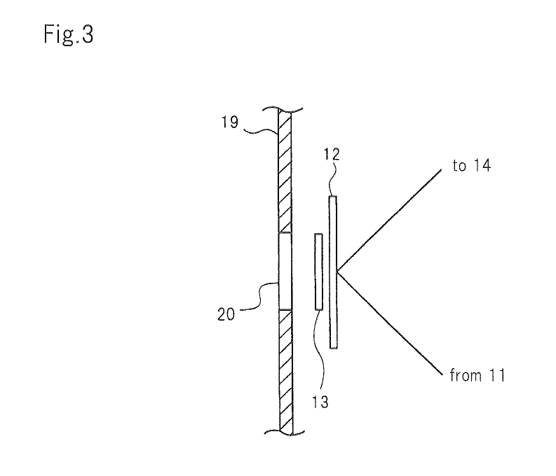

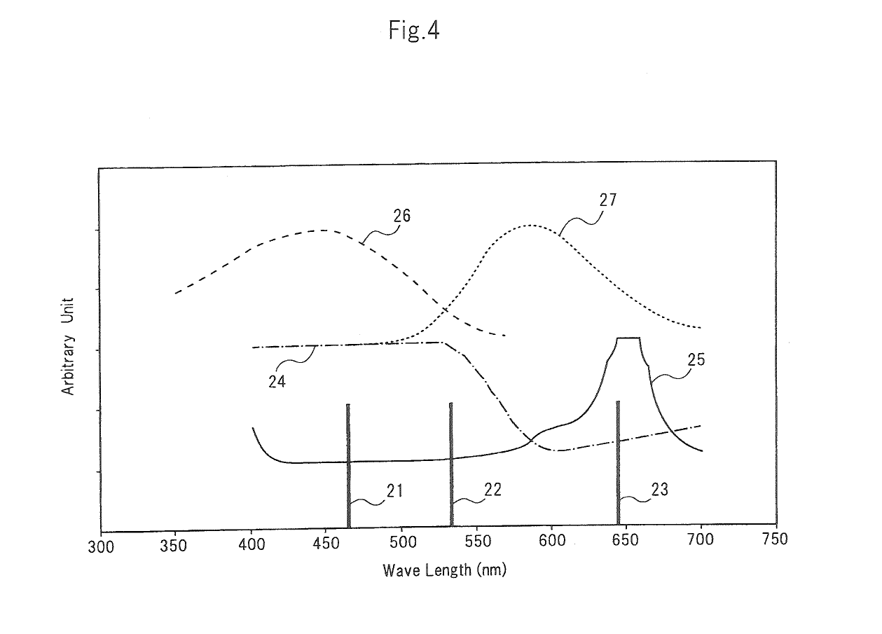

### BRIEF DESCRIPTION OF DRAWINGS

[FIG. 1] is a perspective view showing the structure of a projector according to an embodiment of the present invention.

[FIG. 2]is a schematic view showing the structure of an optical system located in projector 3.

[FIG. 3] is a layout diagram showing the relationship of the positions of enclosure 19 of projector 3 and marker plate 13, enclosure 19 enclosing the optical system shown in FIG. 2.

[FIG. 4] is a schematic diagram showing oscillation wavelengths of blue, green and red laser beams used in the embodiment of the present invention, these wavelengths being designated by 21 to 23; wavelength dependency characteristics of light absorption in a blue-green range protection film and a red range protection film coated on protective eyeglasses that the worker wears, these wavelength dependency characteristics being designated by 24 and 25; excitement wavelength and fluorescent wavelength of a fluorescent material that is composed of marker plate 13, the excitement wavelength and fluorescent wavelength being designated by 26 and 27, respectively.

### BEST MODES THAT CARRY OUT THE INVENTION

Next, embodiments of the present invention will be described with reference to the accompanying drawings.

FIG. 1 shows a perspective view showing the structure of a projector according to an embodiment of the present invention.

Projector 3 according to the embodiment shown in FIG. 1 projects image light using laser beams that are output from laser beam source device 4. A green laser beam and a blue laser beam are supplied from laser beam source device 4 to projector 3 through optical fiber 1; a red laser beam through optical fiber 2.

FIG. 2 shows a schematic diagram showing the structure of an optical system located in projector 3. Although projector 3 is actually provided with not only the structure shown in FIG. 2 and a signal processing system that inputs an image signal and that generates image light, FIG. 2 only shows the principal portions of the optical system.

The green laser beam and blue laser beam supplied through optical fiber 1 and the red laser beam supplied through optical fiber 2 enter dichroic minor 7 through lens 5 and lens 6. Dichroic minor 7 combines these laser beams and outputs the combined laser beam. The combined laser beam that is output from dichroic mirror 7 enters diffusing plate 8. Diffusing plate 8 diffuses the combined laser beam. The diffused light enters rod integrator 9. Rod integrator 9 equalizes the diffused light. The equalized light enters diffusing plate 10. Diffusing plate 10 further diffuses the equalized light.

The diffused light travels to mirror 12 through lens 11. Minor 12 reflects the diffused light to color separation optical system 14. Color separation optical system 14 is composed of a plurality of prisms so as to provide a wavelength-based space separation function. Color separation optical system 14 separates the laser beam combined by dichroic minor 7 into a red laser beam, a green laser beam, and a blue laser beam and outputs these laser beams to DMD 15, DMD 16, and DMD 17 that form a red image, a green image, and a blue image, respectively. The red image, green image, and blue image that are reflected from DMDs 15 to 17 enter image light combining optical system 18.

Like color separation optical system 14, image light combining optical system 18 is composed of a plurality of prisms so as to provide a function that combines beams having different wavelengths. Image light combining optical system 18 combines red image light, green image light, and blue image light and projects the combined image light to the outside. Instead of color separation optical system 14 and image light combining optical system 18, a Phillips prism and a total internal-reflection prism (TIR prism) may be used.

Located on the rear surface, the non-reflection surface, of minor 12, is marker plate 13. Most of the laser beams of individual colors are reflected by minor 12. However, a small fraction of the laser beams of the individual colors leaks out from the rear surface of minor 12. The leaked light enters marker plate 13. Part or all of marker plate 13 is composed of fluorescent material. The leaked light that is transmitted through mirror 12 excites the fluorescent material. As a result, the fluorescent material generates fluorescence that indicates to the user of the projector or the worker who adjusts the positions of the optical elements that the laser beams are being output.

FIG. 3 shows a layout diagram showing the relationship of the positions of enclosure 19 of projector 3, which encloses the optical system shown in FIG. 2, and marker plate 13.

FIG. 3 shows the relationship of the positions of enclosure 19 of projector 3 and marker plate 13 while projector 3 is projecting image light. When the projector operates as shown in FIG. 3, display window 20 is located in the neighborhood of marker plate 13 of enclosure 19. Display window 20 is composed of a material through which fluorescence generated in marker plate 13 is transmitted. The user of the projector can check through display window 20 for fluorescence that indicates to him or her that the laser beams are being output.

When the locations of the optical elements are adjusted, enclosure 19 is detached or opened from the main body of projector 3. At this point, the worker who adjusts the locations of the optical elements can confirm whether or not the laser beams are being output based on the fluorescence of marker plate 13.

According to the foregoing embodiment, since a marker plate that generates fluorescence excited by laser beams is used, during the period in which the laser beams are being output, fluorescence always occurs. The result is that, due to the fluorescence, the user and worker will, without fail, obtain an indication that the laser beams are being output.

FIG. 4 shows a schematic diagram showing oscillation wavelengths of laser beams of blue, green, and red used in the embodiment of the present invention, these wavelengths being designated by 21 to 23; wavelength dependency characteristics of light absorption in a blue-green protection film and a red protection film coated on protective eyeglasses that the worker wears, these wavelength dependency characteristics being designated by 24 and 25; excitement wavelength and fluorescent wavelength of a fluorescent material that makes up marker plate 13, the excitement wavelength and fluorescent wavelength being designated by 26 and 27, respectively.

As shown in FIG. 4, the blue-green protection film absorbs light of a wavelength band including the oscillation wavelengths of the blue and green laser beams; the red protection film absorbs light of a wavelength band including the oscillation wavelength of the red laser beam. The absorptivity of each of the protection films is low at the peak wavelength of the fluorescent wavelength of the fluorescent material that makes up marker plate 13. Thus, when a worker wears protective eyeglasses, although they shut out the laser beams, he or she can check for the fluorescence of marker plate 13.

As shown in FIG. 4, the blue laser beam excites the fluorescent material that makes up marker plate 13, blue being the highest in the three color laser beams. Although the excitement wavelength of the fluorescent material that the red laser beam excites is not shown, the red laser beam also excites the fluorescent material, but to a lower extent than does the blue laser beam. The fluorescent material according to the present invention needs to satisfy the condition that the wavelength of the fluorescence excited by the laser beams used in the projector be different from the wavelengths of the laser beams. The fluorescence excited by the red laser beam may be enhanced by using fluorescent material that is excited by the oscillation wavelength of the red laser beam.

According to the foregoing embodiment, projector 3 that projects image light using laser beams supplied from laser beam source device 4 through optical fibers 2 and 3 was described. Alternatively, the present invention can be applied to an integrated device in which the laser beam source device is built in the projector.

### DESCRIPTION OF REFERENCE NUMERALS

1, 2 Optical fibers

3 Projector

4 Laser beam source device

1-4. (canceled)

5. A projector that has a light modulating device that uses laser beams as display image light, comprising:
a marker plate that is located on a non-reflection surface of a mirror that reflects said laser beams to said light modulating device, said marker plate being excited by said laser beams and generating fluorescence having a wavelength different from those of said laser beams.

6. The projector as set forth in claim 5, further comprising:
a display window located on an enclosure of said projector,
wherein said display window is located at a position in the neighborhood of said marker plate when said projector operates and outputs display image light, said display window includes a material through which fluorescence that occurs in said marker plate is transmitted.

7. The projector as set forth in claim 5,
wherein said laser beams are supplied through an optical fiber.

8. The projector as set forth in claim 6,
wherein said laser beams are supplied through an optical fiber.

9. The projector as set forth in claim 5, further comprising:
a laser beam source device that emits said laser beams.

10. The projector as set forth in claim 6, further comprising:
a laser beam source device that emits said laser beams.
